(19) United States
(12) Patent Application Publication
(10) Pub. No.: US 2026/0264479 A1
(43) Pub. Date: Sep. 10, 2026

(54) COOLING SYSTEM

(71) Applicant: ISUZU MOTORS LIMITED, Yokohama-shi (JP)

(72) Inventor: Tomofuyu MATSUUKI, Fujisawa-shi (JP)

(21) Appl. No.: 19/531,719

(22) Filed: Feb. 6, 2026

(30) Foreign Application Priority Data
Mar. 7, 2025 (JP) 2025-036157

(51) Int. Cl. B60H 1/32; B60H 1/00

(52) U.S. Cl. CPC B60H 1/3228; B60H 1/00278; B60H 1/00735; B60H 1/00885

(57) ABSTRACT

A cooling system includes a circulation flow path through which a refrigerant circulates between a condenser and an evaporator, a first expansion valve that is provided downstream of the condenser and upstream of the evaporator, a first branch flow path that branches from upstream of the first expansion valve and merges at downstream of the evaporator, a second expansion valve that is provided in the first branch flow path, a cooling plate that is provided downstream of the second expansion valve and exchanges heat with a battery, a second branch flow path that branches from downstream of the first expansion valve and merges at downstream of the second expansion valve, an opening/closing valve that is provided in the second branch flow path, and a control device.

### CROSS-REFERENCE TO RELATED APPLICATIONS

The present application claims priority to Japanese Patent Application number 2025-036157, filed on March 7, 2025, contents of which are incorporated herein by reference in its entirety.

### BACKGROUND OF THE INVENTION

The present disclosure relates to a cooling system.

A conventional vehicle thermal management system cools a passenger compartment by causing a refrigerant that has passed through a first expansion valve provided downstream of a condenser to exchange heat with an evaporator, and cools a battery by causing a refrigerant that has passed through a second expansion valve provided downstream of the condenser to exchange heat with a heat-conducting element (for example, Japanese Unexamined Patent Application Publication (Translation of PCT Application) No. 2023-536108).

The expansion valve that supplies the refrigerant to a cooling plate that exchanges heat with the battery is opened and closed based on the temperature of the battery rather than a degree of superheat of the refrigerant. Accordingly, the temperature of the refrigerant becomes higher or lower than a saturation temperature. As a result, insufficient cooling of the refrigerant causes superheated vapor refrigerant to exchange heat with the cooling plate, or overcooling of the refrigerant causes some of the refrigerant that has exchanged heat with the cooling plate not to evaporate. Consequently, a problem arises in that it is difficult to cool the battery to a predetermined temperature.

### BRIEF SUMMARY OF THE INVENTION

The present disclosure focuses on this point, and an object thereof is to facilitate cooling of a battery to a predetermined temperature.

### MEANS FOR SOLVING THE PROBLEMS

An aspect of the present disclosure provides a cooling system including a circulation flow path through which a refrigerant circulates between a condenser that condenses the refrigerant and an evaporator that exchanges heat between air in a vehicle interior and the refrigerant, a first expansion valve that is provided downstream of the condenser and upstream of the evaporator in the circulation flow path and reduces temperature and pressure of the refrigerant, a compressor that is provided downstream of the evaporator and upstream of the condenser in the circulation flow path and compresses the refrigerant, a first branch flow path that branches from a first branch point downstream of the condenser and upstream of the first expansion valve in the circulation flow path and merges at a first junction point downstream of the evaporator and upstream of the compressor in the circulation flow path, a second expansion valve that is provided in the first branch flow path and reduces temperature and pressure of the refrigerant, a cooling plate that is provided downstream of the second expansion valve in the first branch flow path and exchanges heat with a battery, a second branch flow path that branches from a second branch point downstream of the first expansion valve and upstream of the evaporator in the circulation flow path and merges at a second junction point downstream of the second expansion valve and upstream of the cooling plate in the first branch flow path, an opening/closing valve that is provided in the second branch flow path and opens and closes the second branch flow path, and a control device that controls the first expansion valve, the second expansion valve, and the opening/closing valve.

### BRIEF DESCRIPTION OF THE DRAWINGS

FIG. 1 shows an overview of a cooling system 1.

FIG. 2 shows a state in which an opening/closing valve 31 is opened and a second expansion valve 21 is closed.

FIG. 3 shows a state in which the opening/closing valve 31 is closed and the second expansion valve 21 is opened.

FIG. 4 shows an example of a processing sequence in a control device 44.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### An outline of a cooling system 1

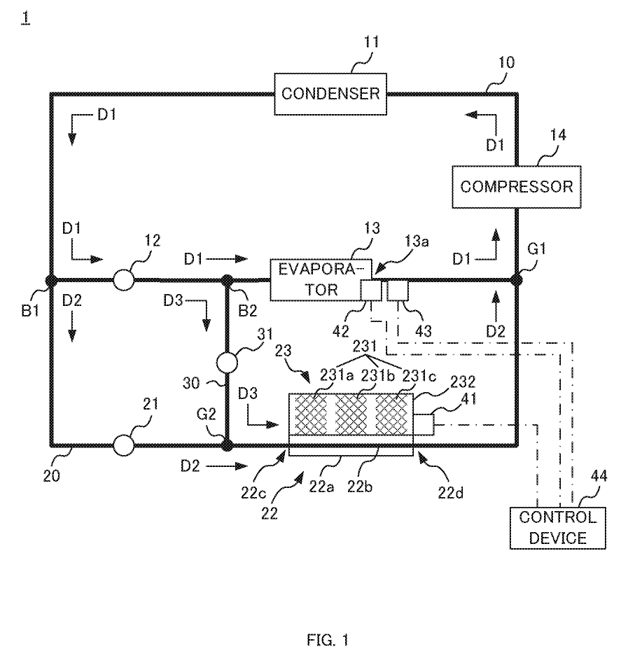

FIG. 1 shows an overview of a cooling system 1. The cooling system 1 shown in FIG. 1 includes a circulation flow path 10, a condenser 11, a first expansion valve 12, an evaporator 13, a compressor 14, a first branch flow path 20, a second expansion valve 21, a cooling plate 22, a battery 23, a second branch flow path 30, an opening/closing valve 31, a first temperature sensor 41, a second temperature sensor 42, a temperature sensing bulb 43, and a control device 44. The cooling system 1 is provided in a vehicle and has a function of cooling air in a vehicle interior of a vehicle and the battery 23. The vehicle is a vehicle including a motor as a drive source, and is, for example, an Electric Vehicle (EV) such as a Battery Electric Vehicle (BEV), a Hybrid Electric Vehicle (HEV), a Fuel Cell Electric Vehicle (FCEV), or the like.

The circulation flow path 10 is a flow path through which a refrigerant circulates between the condenser 11 and the evaporator 13. In the circulation flow path 10, the condenser 11, the first expansion valve 12, the evaporator 13, and the compressor 14 are provided along a direction D1 in which the refrigerant flows. The condenser 11 is a condenser that is provided downstream of the compressor 14 in the circulation flow path 10 and condenses a gaseous refrigerant compressed by the compressor 14. The condenser 11 condenses the refrigerant by exchanging heat between the refrigerant and traveling air, for example.

The first expansion valve 12 is a valve that is provided downstream of the condenser 11 and upstream of the evaporator 13 in the circulation flow path 10, and reduces the temperature and pressure of the refrigerant. The first expansion valve 12 receives a valve opening degree signal indicating a valve opening degree from the control device 44 and allows the refrigerant to pass therethrough by opening the valve with the valve opening degree corresponding to the valve opening degree signal, for example. The first expansion valve 12 reduces the pressure of the refrigerant condensed in the condenser 11 by allowing the refrigerant to pass therethrough. As a result, the refrigerant expands and the temperature of the refrigerant decreases.

The evaporator 13 is an evaporator that is provided downstream of the first expansion valve 12 in the circulation flow path 10 and exchanges heat between air in the vehicle interior and the refrigerant. The evaporator 13 cools intake air discharged by a fan (not shown in figures) by exchanging heat between the intake air and the refrigerant flowing from the first expansion valve 12, for example, and discharges the cooled intake air into the vehicle interior. In the evaporator 13, the refrigerant evaporates (vaporizes) due to heat exchange between the refrigerant and the intake air. The compressor 14 is a compressor that is provided downstream of the evaporator 13 and upstream of the condenser 11 in the circulation flow path 10 and compresses the vaporized refrigerant. The compressor 14 compresses a drawn refrigerant by rotational motion of a rotor, for example.

The first branch flow path 20 is a flow path that branches from a first branch point B1 downstream of the condenser 11 and upstream of the first expansion valve 12 in the circulation flow path 10, and merges at a first junction point G1 downstream of the evaporator 13 and upstream of the compressor 14 in the circulation flow path 10. The first branch flow path 20 is provided with the second expansion valve 21 and the cooling plate 22 along the direction D2 in which the refrigerant flows. With the first branch flow path 20 provided in this manner, the refrigerant condensed by the condenser 11 can flow to the cooling plate 22.

The second expansion valve 21 is a valve that is provided in the first branch flow path 20 and reduces the temperature and pressure of the refrigerant. The second expansion valve 21 receives, from the control device 44, a valve opening signal for instructing opening of the valve or a valve closing signal for instructing closing of the valve, for example. Upon receiving the valve opening signal, the second expansion valve 21 opens the valve to allow the refrigerant to pass therethrough. The second expansion valve 21 reduces the pressure of the refrigerant condensed in the condenser 11 by allowing the refrigerant to pass therethrough. As a result, the refrigerant expands and the temperature of the refrigerant decreases. Upon receiving the valve closing signal, the second expansion valve 21 closes the valve and does not allow the refrigerant to pass therethrough.

The cooling plate 22 is a plate that is provided downstream of the second expansion valve 21 in the first branch flow path 20 and exchanges heat with the battery 23. FIG. 1 shows a configuration in which the cooling plate 22 is provided in the lower portion of the battery 23 as an example, but the cooling plate 22 may be provided in the upper portion or the side portion of the battery 23, or may be provided so as to cover the battery 23.

The cooling plate 22 includes a plate 22a and an in-plate flow path 22b. The plate 22a is composed of a plurality of plates formed of metal, and one or more of the plurality of plates are provided so as to be in contact with the battery 23. The in-plate flow path 22b is a flow path provided between the plurality of plates or inside each of the plurality of plates, and the refrigerant flowing through the first branch flow path 20 passes therethrough. In the cooling plate 22, the refrigerant flowing through the in-plate flow path 22b and the battery 23 in contact with the plate 22a exchange heat, so that the battery 23 is cooled.

The battery 23 is a battery pack including one or more battery cells (for example, lithium ion battery cells) capable of charging and discharging electricity. The battery 23 includes one or more battery cells 231 and a case 232 that houses the one or more battery cells 231. The battery cell 231 is a secondary battery, for example. FIG. 1 shows three battery cells 231 (231a, 231b, and 231c) as an example. The first temperature sensor 41 is a sensor that detects the temperature of the battery 23. The second temperature sensor 42 is a sensor that detects the temperature of the evaporator 13. The temperature sensing bulb 43 is a device that is provided downstream of the evaporator 13 in the circulation flow path 10 and detects the temperature of the refrigerant that has passed through the evaporator 13.

The control device 44 is a computer, for example, and includes a storage unit and a control unit. The storage unit includes a storage medium such as a Read Only Memory (ROM), a Random Access Memory (RAM), a Hard Disk Drive (HDD), or a Solid State Drive (SSD), and stores a program to be executed by the control unit. The control unit includes a processor such as a Central Processing Unit (CPU) or an Electronic Control Unit (ECU). By executing the program stored in the storage unit, the control unit controls the valve opening degree of the first expansion valve 12 based on the temperature of the refrigerant detected by the temperature sensing bulb 43, and controls the opening and closing of the second expansion valve 21 based on the temperature of the battery 23 detected by the first temperature sensor 41.

The control device 44 determines the valve opening degree of the first expansion valve 12 based on the difference between the temperature of the refrigerant at an outlet of the evaporator 13 detected by the temperature sensing bulb 43 and the saturation temperature of the refrigerant (a so-called degree of superheat). Accordingly, the refrigerant that has passed through the first expansion valve 12 is reduced in pressure (i.e., cooled) so as to increase a likelihood that the refrigerant completely evaporates in the evaporator 13. As a result, the cooling system 1 is capable of cooling air in the vehicle interior so that a temperature of the air approaches a requested temperature set by a vehicle occupant.

On the other hand, the control device 44 controls the opening and closing of the second expansion valve 21 based on the temperature of the battery 23 detected by the first temperature sensor 41, rather than the degree of superheat of the refrigerant flowing through the cooling plate 22. Therefore, the temperature of the refrigerant passing through the second expansion valve 21 is higher or lower than the saturation temperature. As a result, in the cooling plate 22, insufficient cooling of the refrigerant may cause heat exchange between the battery 23 and the refrigerant in a superheated vapor state, or overcooling of the refrigerant may cause a decrease in the likelihood that the refrigerant having exchanged heat with the battery 23 completely evaporates. As a result, it is difficult for the cooling system 1 to cool the refrigerant such that the temperature of the battery 23 reaches a predetermined temperature.

Therefore, the cooling system 1 further includes the second branch flow path 30 and the opening/closing valve 31. The second branch flow path 30 is a flow path that i) branches from a second branch point B2 downstream of the first expansion valve 12 and upstream of the evaporator 13 in the circulation flow path 10, and ii) merges at a second junction point G2 downstream of the second expansion valve 21 and upstream of the cooling plate 22 in the first branch flow path 20. In the second branch flow path 30, the refrigerant flows in a direction D3. With the second branch flow path 30 provided in this manner, the cooling system 1 can cause the refrigerant that has passed through the first expansion valve 12 to flow to the cooling plate 22.

The opening/closing valve 31 is a valve that is provided in the second branch flow path 30 and opens and closes the second branch flow path 30. The opening/closing valve 31 receives a valve opening signal for instructing opening of the valve or a valve closing signal for instructing closing of the valve from the control device 44. The opening/closing valve 31 causes the refrigerant to flow in the direction D3 by opening the valve upon receiving the valve opening signal, and causes the refrigerant not to flow through the second branch flow path 30 by closing the valve upon receiving the valve closing signal. By providing the opening/closing valve 31 in this manner, the cooling system 1 can switch between a) supplying the cooling plate 22 with the refrigerant that has passed through the first expansion valve 12 and b) supplying the cooling plate 22 with the refrigerant that has passed through the second expansion valve 21.

The control device 44 controls the opening/closing valve 31 and the second expansion valve 21 based on the temperature of the battery 23 detected by the first temperature sensor 41 and the temperature of the evaporator 13 detected by the second temperature sensor 42. The control device 44 controls the opening and closing of the opening/closing valve 31 and the opening and closing of the second expansion valve 21 to switch between a) supplying the cooling plate 22 with the refrigerant that has passed through the first expansion valve 12 and b) supplying the cooling plate 22 with the refrigerant that has passed through the second expansion valve 21.

For example, when the difference between the temperature of the battery 23 and the temperature of the evaporator 13 falls within a predetermined range, the cooling system 1 supplies the cooling plate 22 with the refrigerant that has passed through the first expansion valve 12, thereby increasing the likelihood that the refrigerant completely evaporates in the cooling plate 22. The predetermined range is ±5°C, for example. On the other hand, when the difference between the temperature of the battery 23 and the temperature of the evaporator 13 is not within the predetermined range, the cooling system 1 supplies the cooling plate 22 with the refrigerant having passed through the second expansion valve 21, thereby causing heat exchange between the cooling plate 22 and a refrigerant having a temperature different from that of the refrigerant supplied to the evaporator 13. By operating as described above, the cooling system 1 can facilitate cooling of the battery 23 to the predetermined temperature (e.g., 40°C).

The operation of the control device 44 will be described in detail below.

### Operation of control device 44

The control device 44 acquires the temperature of the battery 23, the temperature of the evaporator 13, and the temperature of the refrigerant flowing through the evaporator 13 in the circulation flow path 10. The control device 44 acquires the temperature detected by the temperature sensing bulb 43 as the temperature of the refrigerant flowing through the evaporator 13. The control device 44 acquires, as the temperature of the evaporator 13, the temperature of an outlet 13a of the evaporator 13 from the second temperature sensor 42.

The control device 44 acquires, as the temperature of the battery 23, the temperature of the battery 23 at a position closer to an outlet 22d of the cooling plate 22 than an inlet 22c of the cooling plate 22 from the first temperature sensor 41. For example, the control device 44 acquires, as the temperature of the battery 23, the temperature of the battery cell 231 at a position closer to the outlet 22d of the cooling plate 22 than the inlet 22c of the cooling plate 22, among the plurality of battery cells 231. Specifically, the control device 44 acquires the temperature of the battery cell 231c shown in FIG. 1. By operating in this manner, the control device 44 can acquire the temperature of a battery cell 231 that is most difficult to cool by the cooling plate 22 among the plurality of battery cells 231.

The control device 44 adjusts the valve opening degree of the first expansion valve 12 based on the temperature of the refrigerant detected by the temperature sensing bulb 43. The control device 44 calculates, for example, the difference between the temperature detected by the temperature sensing bulb 43 and the saturation temperature of the refrigerant (the degree of superheat). For example, by referring to valve opening information stored in the storage unit that indicates the valve opening degree corresponding to the degree of superheat, the control device 44 identifies a valve opening degree corresponding to a calculated degree of superheat, and outputs a valve opening signal indicating the valve opening degree to the first expansion valve 12.

For example, the control device 44 increases the valve opening degree of the first expansion valve 12 as the degree of superheat, which is the difference between the temperature of the refrigerant flowing through the evaporator 13 and the saturation temperature of the refrigerant, detected by the temperature sensing bulb 43 becomes larger. By operating in this manner, the control device 44 can cool the refrigerant to a greater extent as the degree of superheat of the refrigerant having passed through the evaporator 13 in the circulation flow path 10 becomes larger. Further, by adjusting the valve opening degree based on the degree of superheat to cool the refrigerant, the control device 44 increases the likelihood that the refrigerant completely evaporates in the evaporator 13.

The control device 44 opens and closes the second expansion valve 21 based on the temperature of the battery 23 detected by the first temperature sensor 41. For example, the control device 44 outputs the valve opening signal to the second expansion valve 21 to open the second expansion valve 21, and outputs the valve closing signal to the second expansion valve 21 to close the second expansion valve 21.

For example, the control device 44 opens the second expansion valve 21 when the temperature of the battery 23 is equal to or higher than a threshold value, and closes the second expansion valve 21 when the temperature of the battery 23 is lower than the threshold value. The threshold value is a temperature equal to or lower than an appropriate temperature of the battery 23, and is, for example, a fixed value of not less than 20°C and not more than 40°C.

By operating as described above, the control device 44 causes the second expansion valve 21 to cool the refrigerant so that the temperature of the battery 23 approaches the appropriate temperature. However, since the control device 44 opens and closes the second expansion valve 21 based on the temperature of the battery 23 rather than the degree of superheat of the refrigerant that has exchanged heat with the battery 23, the temperature of the refrigerant flowing into the cooling plate 22 becomes lower or higher than the saturation temperature. As a result, in the cooling plate 22, insufficient cooling of the refrigerant or overcooling of the refrigerant may cause difficulty in cooling of the battery 23 or reduction of the cooling efficiency.

Specifically, when cooling of the refrigerant is insufficient, a state of the refrigerant that has exchanged heat with the battery cell 231a changes to a superheated vapor state. Then, the refrigerant that has transitioned to the superheated vapor state exchanges heat with the battery cell 231b and the battery cell 231c, and so the battery cell 231b and the battery cell 231c cannot be cooled by evaporation heat (latent heat). As a result, in the battery cell 231 included in the battery 23, cooling becomes more difficult at a position closer to the outlet 22d. Further, when the refrigerant is overcooled, some of the refrigerant that has exchanged heat with the battery cell 231 does not evaporate. For this reason, the circulation of the refrigerant is not stabilized in the cooling system 1, and thus the cooling capacity decreases.

Therefore, the control device 44 opens and closes the opening/closing valve 31 and the second expansion valve 21 based on the temperature of the battery 23 detected by the first temperature sensor 41 and the temperature of the evaporator 13 detected by the second temperature sensor 42. For example, when the temperature difference, which is the difference between the temperature of the battery 23 and the temperature of the evaporator 13, is within a predetermined range, the control device 44 opens the opening/closing valve 31 and closes the second expansion valve 21. The predetermined range is not less than −5°C and not more than +5°C, for example.

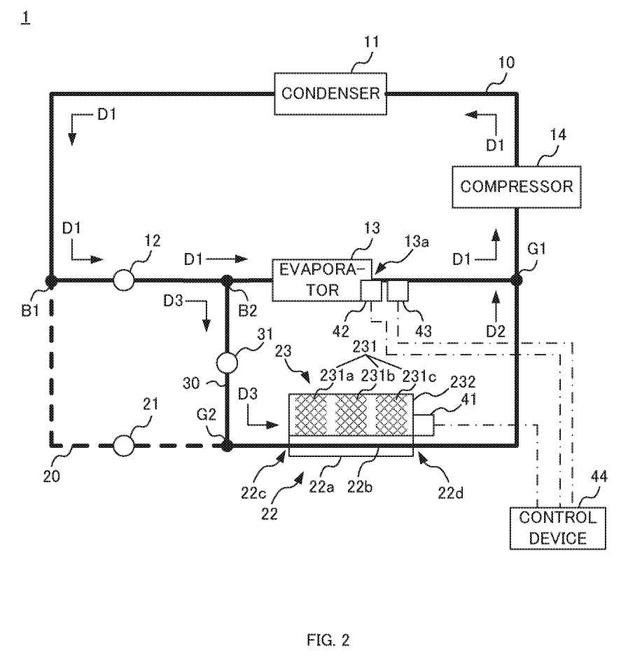

FIG. 2 shows a state in which the opening/closing valve 31 is opened and the second expansion valve 21 is closed. In the cooling system 1, the control device 44 opens the opening/closing valve 31 and closes the second expansion valve 21, so that the refrigerant does not flow in the first branch flow path 20 downstream of the first branch point B1 and upstream of the second junction point G2 (flow path indicated by a broken line in FIG. 2). In the cooling system 1, the refrigerant that has passed through the first expansion valve 12 flows in the direction D3 from the second branch point B2. The refrigerant flows in the direction D3 to exchange heat with the battery 23 in the cooling plate 22. That is, the control device 44 causes the refrigerant having passed through the first expansion valve 12 to exchange heat with the battery 23 by opening the opening/closing valve 31 and closing the second expansion valve 21.

By operating in this manner, the cooling system 1 can supply the cooling plate 22 with the refrigerant that has been reduced in pressure (cooled) by adjusting the valve opening degree of the first expansion valve 12 to cool the evaporator 13 having a temperature close to the temperature of the battery 23. Since the valve opening degree of the first expansion valve 12 is determined based on the degree of superheat, the cooling system 1 can increase the likelihood that the refrigerant completely evaporates in the cooling plate 22 by supplying the cooling plate 22 with the refrigerant that has passed through the first expansion valve 12. As a result, the cooling system 1 can facilitate cooling of the battery 23 to the predetermined temperature and improve the efficiency of cooling the battery 23.

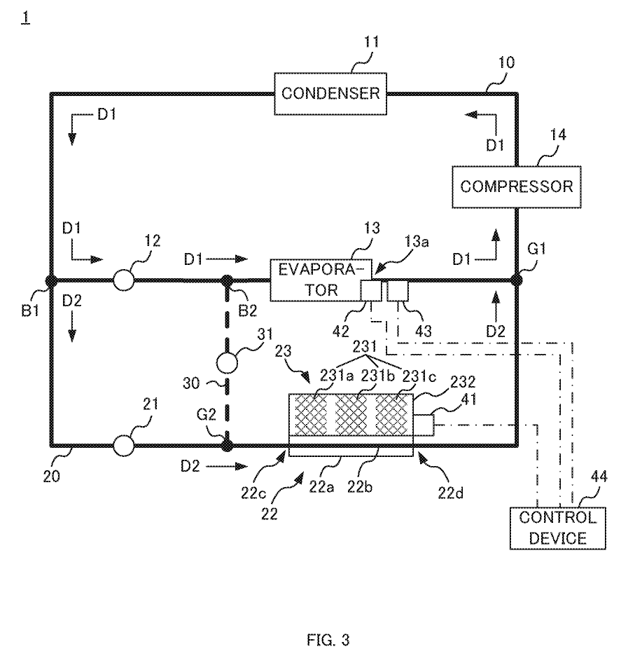

On the other hand, for example, when the temperature difference, which is the difference between the temperature of the battery 23 and the temperature of the evaporator 13, is not within the predetermined range, the control device 44 closes the opening/closing valve 31 and opens the second expansion valve 21. FIG. 3 shows a state in which the opening/closing valve 31 is closed and the second expansion valve 21 is opened. As shown in FIG. 3, in the cooling system 1, the control device 44 closes the opening/closing valve 31 and opens the second expansion valve 21, so that the refrigerant does not flow through the second branch flow path 30. In the cooling system 1, the refrigerant having passed through the first expansion valve 12 flows into the evaporator 13, and the refrigerant having passed through the second expansion valve 21 flows into the cooling plate 22. That is, the control device 44 closes the opening/closing valve 31 and opens the second expansion valve 21 to exchange heat between the refrigerant having passed through the second expansion valve 21 and the battery 23.

With this operation, when the temperature of the battery 23 and the temperature of the evaporator 13 are different from each other, the cooling system 1 can i) cause the refrigerant that has been reduced in pressure to correspond to the temperature of the battery 23 to flow from the second expansion valve 21, and ii) cause the refrigerant that has been reduced in pressure to correspond to the temperature of the evaporator 13 to flow from the first expansion valve 12. That is, the cooling system 1 can supply the battery 23 and the evaporator 13 with respective refrigerants corresponding to the temperature of the battery 23 and the temperature of the evaporator 13, thereby cooling the battery 23 and the evaporator 13.

### Processing sequence in control device 44

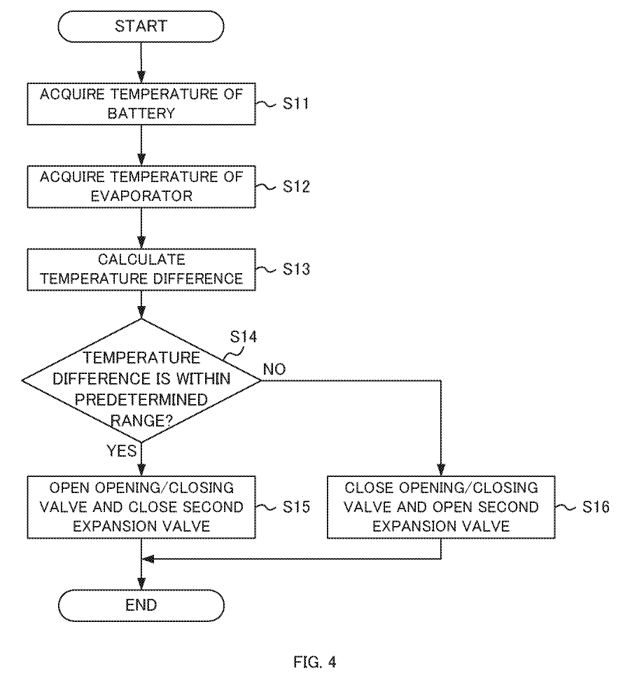

FIG. 4 shows an example of a processing sequence in the control device 44. The processing sequence shown in FIG. 4 is a processing sequence for opening and closing the opening/closing valve 31 and the second expansion valve 21 based on the temperature of the battery 23 and the temperature of the evaporator 13. The control device 44 repeats the processing sequence shown in FIG. 4 at a predetermined cycle (for example, one minute).

The control device 44 acquires the temperature of the battery 23 detected by the first temperature sensor 41 (S11). The control device 44 acquires the temperature of the evaporator 13 detected by the second temperature sensor 42 (S12). The control device 44 calculates a temperature difference that is the difference between the temperature of the battery 23 and the temperature of the evaporator 13 (S13).

If the calculated temperature difference is within the predetermined range (YES in S14), the control device 44 opens the opening/closing valve 31 and closes the second expansion valve 21 (S15) to supply the cooling plate 22 with the refrigerant that has passed through the first expansion valve 12. On the other hand, if the calculated temperature difference is not within the predetermined range (NO in S14), the control device 44 closes the opening/closing valve 31 and opens the second expansion valve 21 (S16) to supply the cooling plate 22 with the refrigerant that has passed through the second expansion valve 21.

### Effects of cooling system 1

As described above, the cooling system 1 includes i) the circulation flow path 10 through which the refrigerant circulates between the condenser 11 that condenses the refrigerant and the evaporator 13 that exchanges heat between the air in the vehicle interior and the refrigerant, ii) the first expansion valve 12 that is provided downstream of the condenser 11 and upstream of the evaporator 13 in the circulation flow path 10 and reduces the temperature and pressure of the refrigerant, iii) the compressor 14 that is provided downstream of the evaporator 13 and upstream of the condenser 11 in the circulation flow path 10 and compresses the refrigerant, iv) the first branch flow path 20 that branches from the first branch point B1 downstream of the condenser 11 and upstream of the first expansion valve 12 in the circulation flow path 10 and merges at the first junction point G1 downstream of the evaporator 13 and upstream of the compressor 14 in the circulation flow path 10, v) the second expansion valve 21 that is provided in the first branch flow path 20 and reduces the temperature and pressure of the refrigerant, vi) the cooling plate 22 that is provided downstream of the second expansion valve 21 in the first branch flow path 20 and exchanges heat with the battery 23, vii) the second branch flow path 30 that branches from the second branch point B2 downstream of the first expansion valve 12 and upstream of the evaporator 13 in the circulation flow path 10 and merges at the second junction point G2 downstream of the second expansion valve 21 and upstream of the cooling plate 22 in the first branch flow path 20, viii) the opening/closing valve 31 that is provided in the second branch flow path 30 and opens and closes the second branch flow path 30, and ix) the control device 44 that controls the first expansion valve 12, the second expansion valve 21, and the opening/closing valve 31.

With the cooling system 1 configured in this manner, the cooling system 1 can supply the cooling plate 22 with the refrigerant that has passed through the first expansion valve 12 opened at the valve opening degree determined based on the degree of superheat, which is the difference between the temperature of the refrigerant and the saturation temperature. As a result, the cooling system 1 can increase the likelihood that the refrigerant completely evaporates in the cooling plate 22, and can facilitate cooling of the battery 23 that exchanges heat with the refrigerant to the predetermined temperature. Further, in the cooling system 1, the refrigerant that has passed through the first expansion valve 12 can flow to the evaporator 13 and the cooling plate 22, thereby efficiently cooling the evaporator 13 and the cooling plate 22.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A cooling system comprising:
a circulation flow path through which a refrigerant circulates between a condenser that condenses the refrigerant and an evaporator that exchanges heat between air in a vehicle interior and the refrigerant;
a first expansion valve that is provided downstream of the condenser and upstream of the evaporator in the circulation flow path and reduces temperature and pressure of the refrigerant;
a compressor that is provided downstream of the evaporator and upstream of the condenser in the circulation flow path and compresses the refrigerant;
a first branch flow path that branches from a first branch point downstream of the condenser and upstream of the first expansion valve in the circulation flow path and merges at a first junction point downstream of the evaporator and upstream of the compressor in the circulation flow path;
a second expansion valve that is provided in the first branch flow path and reduces temperature and pressure of the refrigerant;
a cooling plate that is provided downstream of the second expansion valve in the first branch flow path and exchanges heat with a battery;
a second branch flow path that branches from a second branch point downstream of the first expansion valve and upstream of the evaporator in the circulation flow path and merges at a second junction point downstream of the second expansion valve and upstream of the cooling plate in the first branch flow path;
an opening/closing valve that is provided in the second branch flow path and opens and closes the second branch flow path; and
a control device that controls the first expansion valve, the second expansion valve, and the opening/closing valve.

2. The cooling system according to claim 1, wherein
the control device opens and closes the opening/closing valve based on a temperature of the battery and a temperature of the evaporator.

3. The cooling system according to claim 2, wherein
the control device opens the opening/closing valve and closes the second expansion valve when a temperature difference, which is a difference between the temperature of the battery and the temperature of the evaporator, is within a predetermined range.

4. The cooling system according to claim 2, wherein
the control device closes the opening/closing valve and opens the second expansion valve when a temperature difference, which is a difference between the temperature of the battery and the temperature of the evaporator, is not within a predetermined range.

5. The cooling system according to claim 2, wherein
the battery includes a plurality of battery cells, and
the control device acquires, as the temperature of the battery, a temperature of the battery cell at a position closer to an outlet of the cooling plate than an inlet of the cooling plate, among a plurality of the battery cells.

6. The cooling system according to claim 2, wherein
the control device acquires, as the temperature of the evaporator, a temperature of an outlet of the evaporator.

7. The cooling system according to claim 1, wherein
the control device increases a valve opening degree of the first expansion valve as a degree of superheat, which is a difference between a temperature of the refrigerant flowing through the evaporator and a saturation temperature of the refrigerant, becomes larger.

8. The cooling system according to claim 1, wherein
the control device opens the second expansion valve when a temperature of the battery is equal to or higher than a threshold value, and closes the second expansion valve when the temperature of the battery is lower than the threshold value.

9. The cooling system according to claim 3, wherein
the control device opens the opening/closing valve and closes the second expansion valve to exchange heat between the refrigerant having passed through the first expansion valve and the battery.

10. The cooling system according to claim 4, wherein
the control device closes the opening/closing valve and opens the second expansion valve to exchange heat between the refrigerant having passed through the second expansion valve and the battery.
